(19) United States
(12) Patent Application Publication
(10) Pub. No.: US 2005/0056232 A1
(43) Pub. Date: Mar. 17, 2005

(54) Pet shelter

(76) Inventor: Juliana O'Niell, Harrison, NY (US)

Correspondence Address: Michael R. Friscia;Wolff & Samson PC, One Boland Drive, West Orange,, NJ, 07052, US

(21) Appl. No.: 10/664,709

(22) Filed: Sep. 17, 2003

(51) Int. Cl. A01K 1/02

(52) U.S. Cl. 119/500

(57) ABSTRACT

A shelter for a pet includes an enclosure sized for a pet, having an interior space, a wall separating the interior space from exterior space and at least one opening for pet ingress and egress to the interior space. A thermoelectric cooler is mounted in the wall. A first grill is spaced from the wall having the cooler and separates the cooler from the interior space. A second grill is spaced from the opposite side of the wall having the cooler and separating the cooler from exterior space.

### BACKGROUND OF INVENTION

The present invention relates to pet shelters, and particularly to climate controlled pet shelters for use in an indoor environment. U.S. Pat. No. 5,746,271 discloses a climate controlled pet shelter designed for outdoor use in which a dog house is provided with an air conditioning and heating unit so that an outdoor pet can take shelter therein during hot or cold weather.

Pets are often left inside homes or apartments while the owner is out during the day. Normally this does not pose a problem during cold weather, as such living quarters are usually heated during all hours, even when the owner is away. In order to avoid leaving a pet in a hot environment during summer months, however, the owner is often forced to air condition the entire living space to assure the comfort and health of the pet. This is inefficient and costly to the pet owner. Further, even where air conditioning is not used for the living space an owner may be inclined to close and lock the windows of the living space for security causing the space to become uncomfortably warm.

It is therefore an object of the present invention to provide a pet shelter designed for indoor use wherein a pet can take shelter in a cooled enclosure during hot weather in an un-cooled living space.

### SUMMARY OF THE INVENTION

In accordance with the invention there is provided a shelter for a pet having an enclosure sized for a pet, the enclosure including an interior space having at least one wall separating the interior space from exterior space and at least one opening for ingress and egress to the interior space. A thermoelectric cooler is mounted in one wall of the enclosure. A first grill is provided spaced from the wall having the cooler, and separating the cooler from the interior space. A second grill is provided spaced from the wall having the cooler and separating the cooler from exterior space.

In a preferred arrangement the enclosure includes thermal insulation separating the interior space from exterior space. The opening may be closed by a flexible closure. The flexible closure may be strips of plastic material attached above the opening and extending by gravity to close the opening. The cooler may be mounted in a vertical side wall or in a top wall. The cooler may include first heat convector fins arranged on a side thereof facing the interior space and include a first fan for providing flow of air over the first heat convector fins, and wherein the first grill is spaced from the first fan. The cooler may also include second heat convector fins arranged on a side thereof facing the exterior space and a second fan for providing flow of air over the second heat convector fins, and wherein the second grill is spaced from the second fan.

For a better understanding of the present invention, together with other and further objects thereof, reference is made to the following description, taken in conjunction with the accompanying drawings, and its scope will be pointed out in the appended claims.

### BRIEF DESCRIPTION OF THE DRAWINGS

FIG. 1 is an elevation cross sectional view of a first embodiment of a pet shelter in accordance with the present invention.

FIG. 2 is a rear end elevation view of the pet shelter of FIG. 1 with a grill removed.

FIG. 3 is an elevation view of the exterior grill of the embodiment of a pet shelter shown in FIG. 1.

FIG. 4 is a front end elevation view of the pet shelter of FIG. 1.

FIG. 5 is an elevation cross sectional view of an alternate embodiment of a pet shelter in accordance with the invention.

### DESCRIPTION OF THE INVENTION

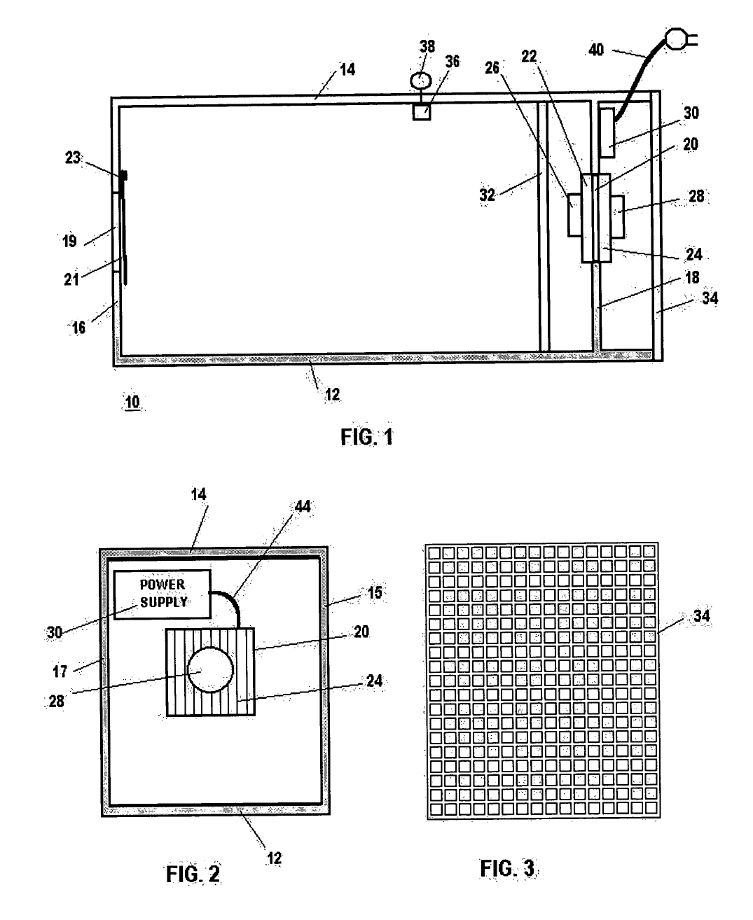

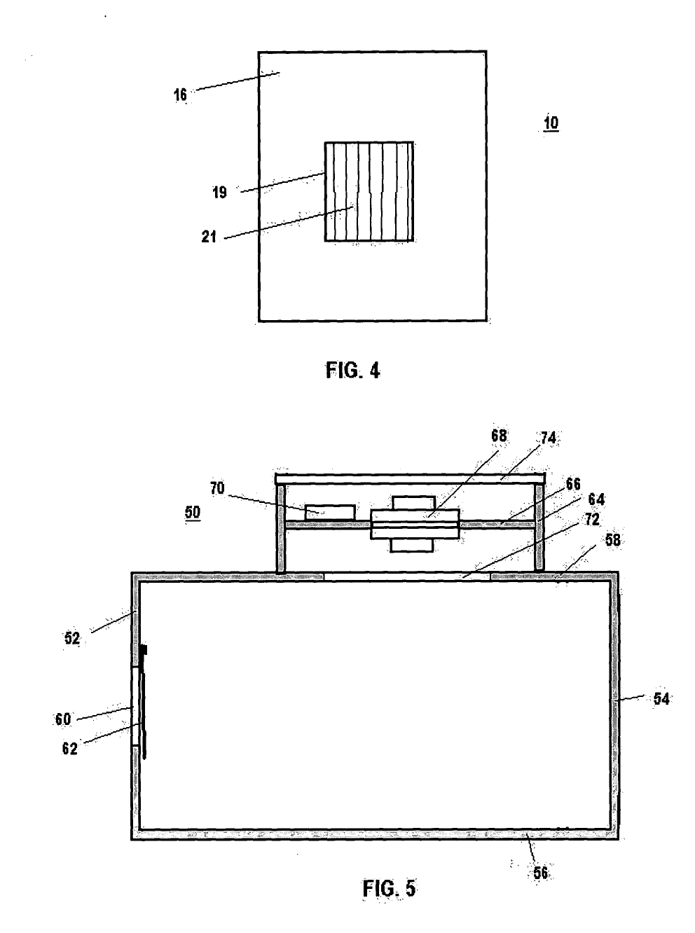

Referring to FIGS. 1 to 4 there is shown a first embodiment of a pet shelter 10 in accordance with the present invention. The pet shelter includes a bottom wall 12, a top wall 14, side walls 15 and 17, front wall 16 and rear wall 18. The walls are preferably made of plastic, wood or similar material and preferably include thermal insulation, such as foam insulation between washable plastic interior and exterior wall surfaces. Optionally one of the walls, such as the top wall 14 may be hinge mounted or include a door for access to the interior of the shelter for cleaning or for retrieving a pet.

Front wall 16 includes an appropriately sized and located opening 19 to permit ingress and egress by a pet. Opening 19 may be closed by a curtain formed of overlapping plastic strips 21, which are attached above the opening, for example by a bracket 23, so that by hanging down under gravity they close opening 19. Optionally a door may be provided to keep a pet within the shelter, for example during transportation.

Bottom wall 12, top wall 14 and side walls 15, 17 extend beyond rear wall 18 forming a recess at the rear end of the shelter. A thermoelectric cooler 20 is mounted through rear wall 18 and includes interior convection fins 22 facing the interior of the shelter and a fan 26 for circulating air over fins 22. Cooler 20 further includes exterior fins 24 and a second fan 28 for circulating air over fins 24. A suitable cooler is available from Melcor of Trenton, N.J. It has been found that a cooler having a capacity of 260 to 280 BTU adequately maintains an appropriate temperature within a shelter having a width of 15 inches, a height of 15 inches and a length of about 24 inches.

A first grill 32 is arranged parallel to rear wall 18 and separates a pet within shelter 10 from cooler 20 and its fan 26. A second grill 34 covers the recess formed by the extended walls and protects pets from fan 28. Grills 32, 34 are spaced about three inches from the interior and exterior of rear wall 18. The grills may be plastic grills having openings of about one-half to one inch square, as illustrated in FIG. 3. Within the recess covered by second grill 34, a power supply 30 having a cord 40 for connection to an electrical outlet is provided for supplying the thermoelectric cooler 20 with DC current over cable 44, which is also used to operate fans 26, 28.

A thermostat control 36 may optionally be provided for controlling the operation of cooler 20. Thermostatic control may have an external control knob 38 for operation by the pet owner.

FIG. 5 is a cross sectional view of an alternate embodiment of a pet shelter 50 having a bottom wall 56, a plain rear wall 54, a top wall 58 and a front wall 52 with opening 60 closed by plastic straps 62. An extension having side walls 64 and an interior horizontal wall 66 is mounted above an opening in top wall 58, which is closed from the interior of the shelter 50 by plastic grill 72. Thermoelectric cooler 68 and power supply 70 are mounted on horizontal wall 66 within the extension. The top of the extension is closed by a second grill 74.

The thermoelectric cooler if continuously running will maintain the interior of shelter 10 or 50 at about 10 degrees F. below the temperature of the environment, and when used in a closed living space without air conditioning will provide a cooling shelter for a pet. Under humid conditions it has been found advantageous to provide a rubber backed bath mat to avoid condensation.

While there have been described what are believed to be the preferred embodiments of the present invention, those skilled in the art will recognize that other and further changes and modifications may be made thereto without departing from the spirit of the present invention, and it is intended to claim all such changes and modifications as fall within the true scope of the invention.

1. A shelter for a pet comprising:
an enclosure sized for a pet, said enclosure including an interior space having at least one wall separating said interior space from exterior space and at least one opening for ingress and egress to said interior space;
a thermoelectric cooler mounted in said at least one wall;
a first grill spaced from said wall having said cooler and separating said cooler from said interior space; and
a second grill spaced from said wall having said cooler and separating said cooler from exterior space.

2. A shelter for a pet as specified in claim 1 wherein said enclosure includes thermal insulation separating said interior space from exterior space.

3. A shelter for a pet as specified in claim 1 wherein said opening is closed by a flexible closure.

4. A shelter for a pet as specified in claim 3 wherein said flexible closure comprises strips of plastic material attached above said opening and extending by gravity to close said opening.

5. A shelter for a pet as specified in claim 1 wherein said wall having said cooler comprises a vertical side wall.

6. A shelter for a pet as specified in claim 1 wherein said wall having said cooler comprises a top wall.

7. A shelter for a pet as specified in claim 1 wherein said cooler includes first heat convector fins arranged on a side thereof facing said interior space and a first fan for providing flow of air over said first heat convector fins, and wherein said first grill is spaced from said first fan.

8. A shelter for a pet as specified in claim 1 wherein said cooler includes second heat convector fins arranged on a side thereof facing said exterior space and a second fan for providing flow of air over said second heat convector fins, and wherein said second grill is spaced from said second fan.

9. A cooled pet shelter comprising:
an enclosure sized for a pet and having an opening for ingress and egress to the interior space;
a thermoelectric cooler mounted to the enclosure;
a first grill positioned between the interior space and the cooler; and
a second grill positioned between the cooler and atmosphere.

10. The pet shelter of claim 9 wherein said enclosure includes thermal insulation separating said interior space from exterior space.

11. The pet shelter of claim 9 wherein the cooler is mounted to a vertical side wall of the enclosure.

12. The pet shelter of claim 9 wherein the cooler is mounted to a top wall of the enclosure.

13. The pet shelter of claim 9 wherein said cooler includes first heat convector fins arranged on a side thereof facing said interior space and a first fan for providing flow of air over said first heat convector fins, and wherein said first grill is spaced from said first fan.

14. The pet shelter of claim 13 wherein said cooler includes second heat convector fins arranged on a side thereof facing said exterior space and a second fan for providing flow of air over said second heat convector fins, and wherein said second grill is spaced from said second fan.

15. The pet shelter of claim 9 further comprising a thermostat control for controlling operation of the cooler.

16. The pet shelter of claim 15 wherein the thermostatic control includes an external control knob.

17. A cooled pet shelter comprising:
an enclosure sited for a pet, the enclosure including forward and rear walls, side walls and an upper wall;
an access opening in one of the front or side walls;
a first grill forming at least a portion of the rear or top wall;
an extension mounted on the enclosure;
a thermoelectric cooler mounted on the extension proximate the first grill; and
a second grill mounted on the extension proximate the thermo electric cooler.

18. The pet shelter of claim 17 wherein said cooler includes first heat convector fins arranged on a side thereof facing said interior space and a first fan for providing flow of air over said first heat convector fins, and wherein said first grill is spaced from said first fan.

19. The pet shelter of claim 18 wherein said cooler includes second heat convector fins arranged on a side thereof facing said exterior space and a second fan for providing flow of air over said second heat convector fins, and wherein said second grill is spaced from said second fan.

20. The pet shelter of claim 17 further comprising a thermostat control for controlling operation of the cooler wherein the thermostatic control includes an external control knob.
